(19) United States
(12) Patent Application Publication
(10) Pub. No.: US 2026/0251380 A1
(43) Pub. Date: Aug. 27, 2026

(54) REFRIGERATOR AND METHOD OF MANUFACTURING THE SAME

(71) Applicant: SAMSUNG ELECTRONICS CO., LTD., Suwon-si (KR)

(72) Inventors: Dongpil SEO, Suwon-s (KR); Jiho JEONG, Suwon-si (KR); Taehyun SUNG, Suwon-si (KR); Jinhyun PARK, Suwon-si (KR); Sangjun PARK, Suwon-si (KR); Donggun KO, Suwon-si (KR)

(73) Assignee: SAMSUNG ELECTRONICS CO., LTD., Suwon-si (KR)

(21) Appl. No.: 19/535,756

(22) Filed: Feb. 10, 2026

Related U.S. Application Data
(63) Continuation of application No. PCT/KR2026/000893, filed on Jan. 15, 2026.

(30) Foreign Application Priority Data
Feb. 14, 2025 (KR) 10-2025-0019717

(51) Int. Cl. F25D 23/06

(52) U.S. Cl. CPC F25D 23/065; F25D 2201/12

(57) ABSTRACT

A refrigerator includes an inner case having a storage compartment therein, an outer case outside the inner case, and an injection molded insulating member in a spaced region between the inner case and the outer case. The injection molded insulating member includes an insulating panel and an insulating material integrally formed together. The insulating material surrounds at least a portion of the insulating panel.

### CROSS-REFERENCE TO RELATED APPLICATIONS

The application is a continuation application, under 35 U.S.C. §111(a), of International Application No. PCT/KR2026/000893, filed on January 15, 2026, which claims priority under 35 U.S.C. §119 to Korean Patent Application No. 10-2025-0019717, filed on February 14, 2025, in the Ministry of Intellectual Property, the disclosures of which are incorporated by reference herein their entireties.

### TECHNICAL FIELD

The present disclosure relates to a refrigerator having an improved structure and a method of manufacturing the same.

### BACKGROUND ART

A refrigerator is a device that is composed of a main body including a storage compartment, and a cold air supply system configured to supply cold air to the storage compartment so as to keep food fresh. The storage compartment includes a refrigerating compartment in which food is kept refrigerated by maintaining the temperature at approximately 0 to 5 degrees Celsius, and a freezing compartment in which food is kept frozen by maintaining the temperature at approximately -30 to 0 degrees Celsius.

The main body of the refrigerator is provided by coupling an inner case and an outer case. The inner case forms the storage compartment, and the outer case forms the exterior of the refrigerator. An insulating member for thermal insulation is disposed between the inner case and the outer case.

The insulating member may include an insulating material such as urethane, or an insulating panel such as a vacuum insulating panel.

### DISCLOSURE

### Technical Problem

One aspect of the present disclosure provides a refrigerator including an insulating member that is injection molded by inserting an insulating panel into an insulating material, and a method of manufacturing the same.

One aspect of the present disclosure provides a refrigerator including an insulating member that may be disposed even in portions having a complicated shape, and a method of manufacturing the same.

One aspect of the present disclosure provides a refrigerator with improved assembly capability, and a method of manufacturing the same.

The technical objectives of the disclosure are not limited to the above, and other objectives that are not described above will be clearly understood by those skilled in the art from the above detailed description.

### Technical Solution

A refrigerator according to an aspect of the disclosure includes: an inner case having a storage compartment therein, an outer case outside the inner case, and an injection molded insulating member disposed in a spaced region between the inner case and the outer case. The injection molded insulating member includes an insulating panel and an insulating material integrally formed together. The insulating material surrounds at least a portion of the insulating panel.

A refrigerator according to an aspect of the disclosure includes: an inner case having a storage compartment therein, an outer case outside the inner case, and an injection molded insulating member in a portion of a spaced region between the inner case and the outer case. The injection molded insulating member includes an insulating panel and a first insulating material integrally formed together. The refrigerator further includes a second insulating material in another portion of the spaced region. The second insulating material is in contact with at least a portion of the injection molded insulating member.

A method of manufacturing a refrigerator according to an aspect of the disclosure includes: providing an inner case having a storage compartment therein and an outer case outside the inner case, injection-molding an insulating member by inserting the insulating panel into the insulating material such that the insulating material surrounds at least a portion of the insulating panel, and assembling the inner case, the outer case, and the insulating member such that the insulating member is disposed between the inner case and the outer case.

### DESCRIPTION OF DRAWINGS

FIG. 1 is a perspective view illustrating a refrigerator according to an embodiment.

FIG. 2 is a cross-sectional view of the refrigerator taken along line A-A′ shown in FIG. 1.

FIG. 3 is a cross-sectional view of the refrigerator taken along line B-B′ shown in FIG. 1.

FIG. 4 is a view illustrating an inner case, an outer case, and an insulating member in a disassembled state according to an embodiment.

FIG. 5 is an enlarged view of region C shown in FIG. 2.

FIG. 6 is a perspective view illustrating a first insulating member according to an embodiment.

FIG. 7 is a cross-sectional view taken along line F-F′ shown in FIG. 6.

FIG. 8 is an enlarged view of region E shown in FIG. 3.

FIG. 9 is a perspective view illustrating a second insulating member according to an embodiment.

FIG. 10 is a cross-sectional view taken along line G-G′ shown in FIG. 9.

FIG. 11 is an enlarged view of region D shown in FIG. 2.

FIG. 12 is a perspective view illustrating a third insulating member according to an embodiment.

FIG. 13 is a cross-sectional view taken along line H-H′ shown in FIG. 12.

FIG. 14 is an enlarged view of a portion of a cross-section of the refrigerator according to an embodiment.

FIG. 15 is a view illustrating a fourth insulating member according to an embodiment.

FIG. 16 is a cross-sectional view taken along line I-I′ shown in FIG. 15.

FIG. 17 is a block diagram illustrating a method of manufacturing a refrigerator according to an embodiment.

### MODES OF THE DISCLOSURE

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulating material provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulating material is positioned between the inner case and the outer case.

The “insulating material” may insulate an inside of the storage compartment from an outside of the storage compartment to maintain inside temperature of the storage compartment at appropriate temperature without being influenced by an external environment of the storage compartment. According to an embodiment of the disclosure, the insulating material may include a foaming insulating material. The foaming insulating material may be molded by fixing the inner case and the outer case with jigs, etc. and then injecting and foaming urethane foam as a mixture of polyurethane and a foaming agent between the inner case and the outer case.

According to an embodiment of the disclosure, the insulating material may include a vacuum insulating material in addition to a foaming insulating material, or may be configured only with a vacuum insulating material instead of a forming insulating material. The vacuum insulating material may include a core material and a cladding material accommodating the core material and sealing the inside with vacuum or pressure close to vacuum. However, the insulating material is not limited to the above-mentioned foaming insulating material or vacuum insulating material, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulating material.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of -20 degrees Celsius to -1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulating material to insulate the storage compartment in a closed state.

According to an embodiment, the door may include an outer door plate forming the front surface of the door, an inner door plate forming the rear surface of the door and facing the storage compartment, an upper cap, a lower cap, and a door insulating material provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Meanwhile, the terms “front and rear direction”, “left and right direction”, “upper side”, and “lower side” used in the description below are defined based on the drawing, and the shape and position of each component are not limited by these terms.

For example, the X-axis may be defined as a front-rear direction. For example, the Y-axis may be defined as a lateral direction. For example, the Z-axis may be defined as an up-down direction. For example, the +X direction may be defined as a forward direction, and the –X direction may be defined as a rearward direction. For example, the +Y direction may be defined as a leftward direction, and the –Y direction may be defined as a rightward direction. For example, the +Z direction may be defined as an upward direction, and the –Z direction may be defined as a downward direction.

Hereinafter, embodiments of the present disclosure will be described in detail with reference to the accompanying drawing.

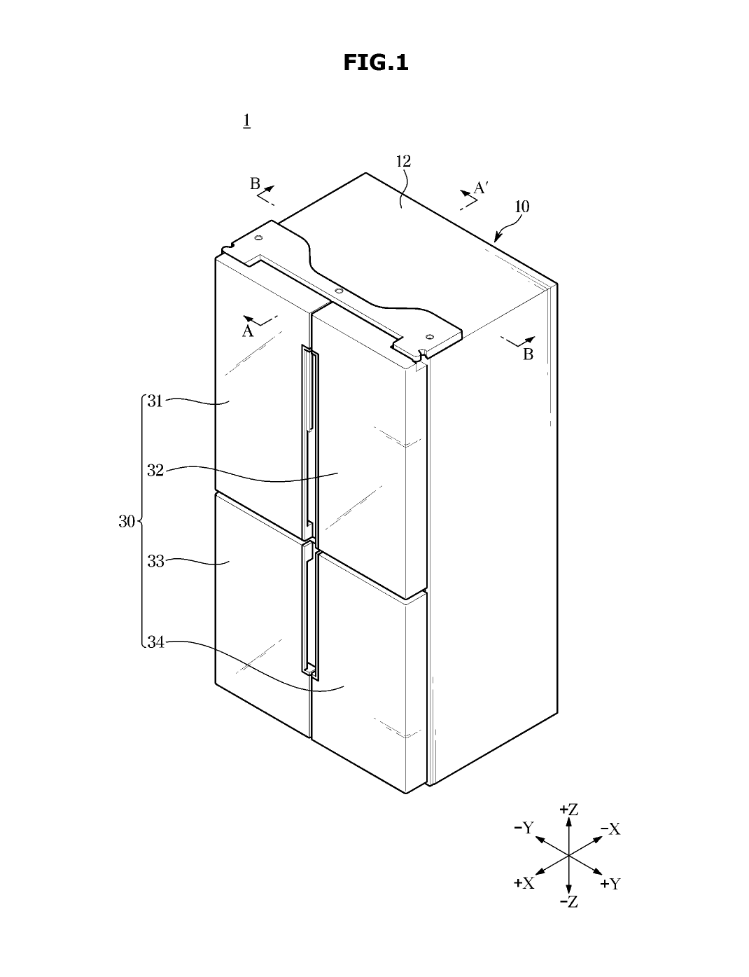

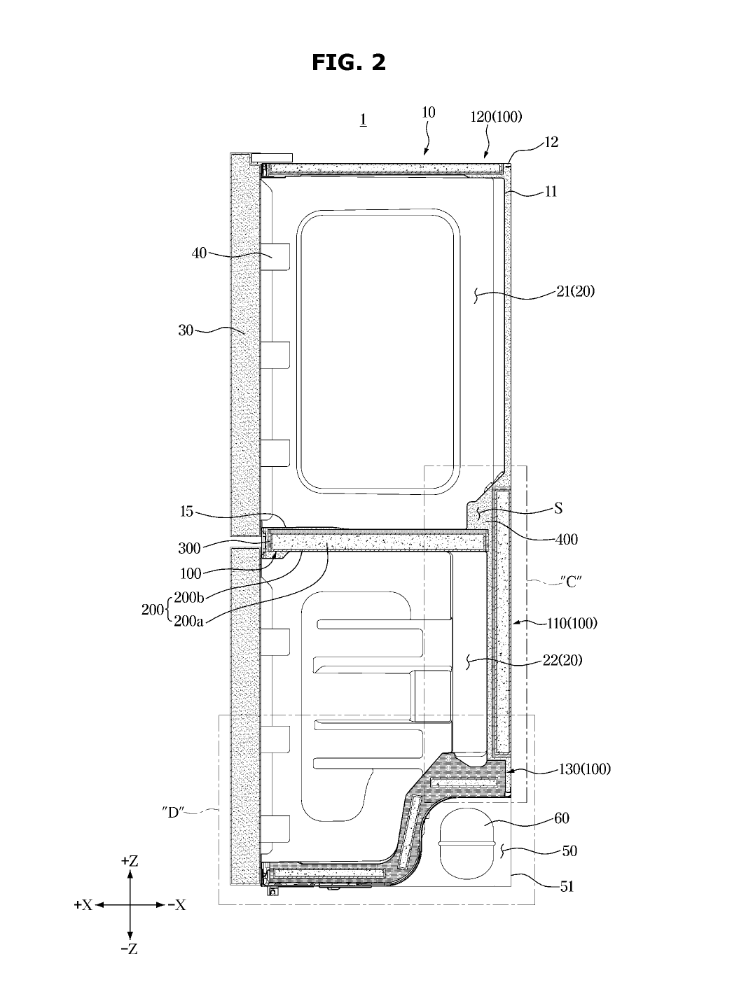

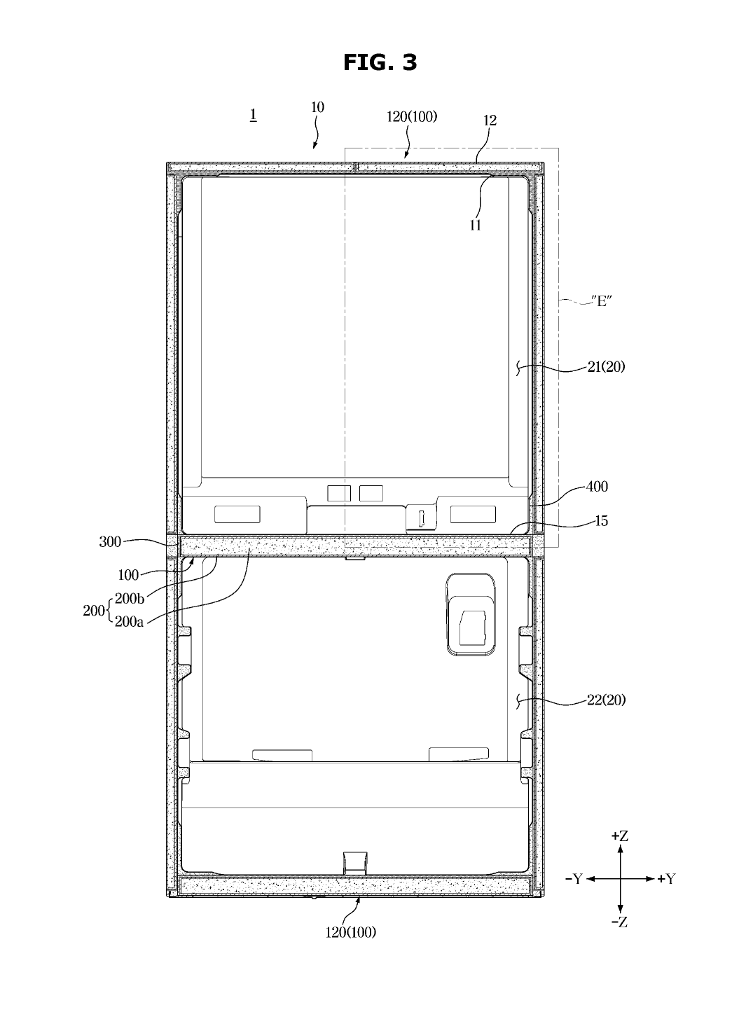

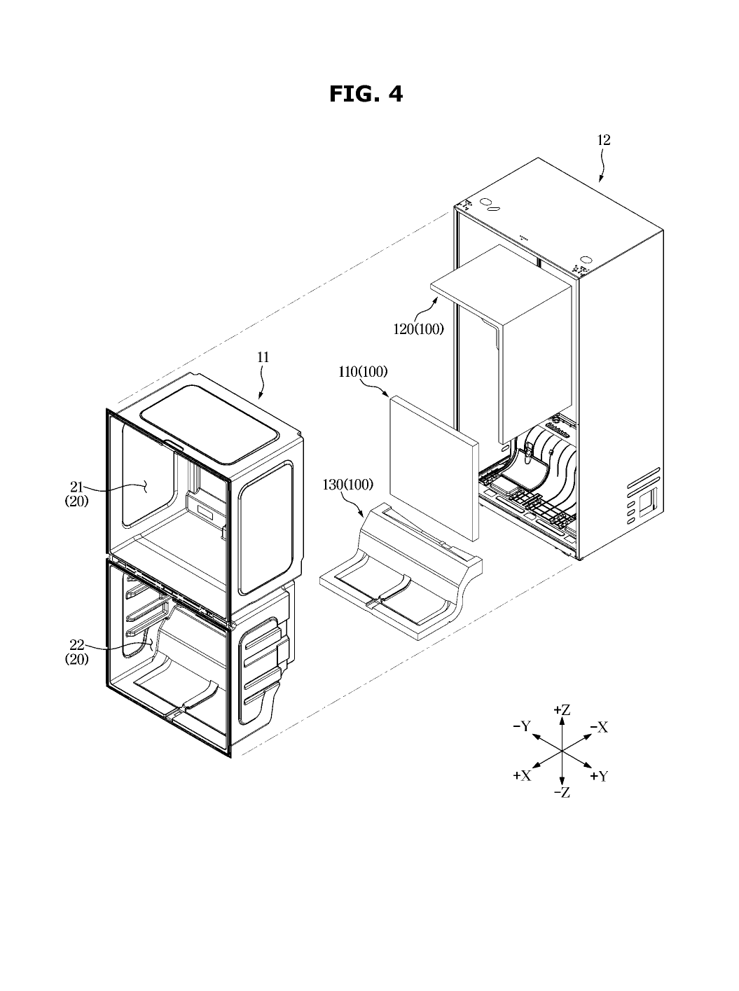

FIG. 1 is a perspective view illustrating a refrigerator according to an embodiment. FIG. 2 is a cross-sectional view of the refrigerator taken along line A-A′ shown in FIG. 1. FIG. 3 is a cross-sectional view of the refrigerator taken along line B-B′ shown in FIG. 1. FIG. 4 is a view illustrating an inner case, an outer case, and an insulating member in a disassembled state according to an embodiment.

Referring to FIGS. 1 to 4, a refrigerator 1 may include a main body 10, a storage compartment 20 provided inside the main body 10, a door 30 configured to open and close the storage compartment 20, and a cold air supply device (not shown) for supplying cold air to the storage compartment 20.

The main body 10 may include an inner case 11 forming the storage compartment 20, and an outer case 12 coupled to an outside of the inner case 11 to form an outer exterior. The inner case 11 may be formed by injection molding of a plastic material, and the outer case 12 may be formed of a metal material

The storage compartment 20 may be divided into a plurality of sections by a horizontal partition 15. Specifically, the storage compartment 20 may be divided into an upper storage compartment 21 and a lower storage compartment 22 by the horizontal partition 15.

Although not shown in the drawings, the lower storage compartment 22 may be divided into two compartments by a vertical partition. For example, the lower storage compartment 22 may be divided into a right lower storage compartment and a left lower storage compartment by the vertical partition.

The upper storage compartment 21 may be used as a refrigerating compartment, and the lower storage compartment 22 may be used as a freezing compartment. However, the division and use of the storage compartments as described above are only an example and are not limited thereto.

Depending on embodiments, the refrigerator may be a side by side (SBS) type in which the storage compartment is divided into left and right sides by a vertical partition, a French door refrigerator (FDR) type in which the storage compartment is divided into an upper refrigerating compartment and a lower refrigerating compartment by a horizontal partition, or a single-door type with one storage compartment and one door.

The refrigerator 1 may include a shelf on which food is placed, and a storage container in which food is stored. Each of the shelf and the storage container may be disposed inside the storage compartment 20. Each of the shelf and the storage container may be provided in plurality.

The cold air supply device may generate cold air by using a cooling cycle in which a refrigerant is compressed, condensed, expanded, and evaporated, and may supply the generated cold air to the storage compartment 20.

Specifically, the cold air supply device may include a compressor 60 for compressing the refrigerant, a condenser (not shown) for condensing the compressed refrigerant, an expansion device (not shown) for expanding the condensed refrigerant, and an evaporator (not shown) for evaporating the expanded refrigerant. The cold air supply device may generate cold air by forming a cooling cycle through the compressor 60, the condenser (not shown), the expansion device (not shown), and the evaporator (not shown), and may supply the generated cold air to the storage compartment 20.

The door 30 may include a first door 31 and a second door 32. The upper storage compartment 21 may be opened and closed by the first door 31 and the second door 32.

Each of the first door 31 and the second door 32 may be rotatably coupled to the main body 10. For example, each of the first door 31 and the second door 32 may be rotatably coupled to the main body 10 by a hinge.

The door 30 may include a third door 33 and a fourth door 34. The third door 33 and the fourth door 34 may be provided to open and close the lower storage compartment 22.

Each of the third door 33 and the fourth door 34 may be rotatably coupled to the main body 10. For example, each of the third door 33 and the fourth door 34 may be rotatably coupled to the main body 10 by a hinge.

The refrigerator 1 may include a door basket 40. The door basket 40 may form a storage space for storing items. The door basket 40 may be provided on a rear surface of the door 30.

The refrigerator 1 may include a machine room 50. The machine room 50 may be configured to accommodate a cold air supply device such as a compressor 60 or a condenser (not shown).

The machine room 50 may be provided inside the main body 10. Specifically, the machine room 50 may be located at a lower rear portion of the main body 10.

The machine room 50 may be provided outside the outer case 12. Accordingly, the storage compartment 20 and the machine room 50 may be separated from each other by the inner case 11, the outer case 12, and an insulating member 100 to be described later.

The refrigerator 1 may include a machine room cover 51. The machine room cover 51, together with an outer surface of the outer case 12, may form the machine room 50. In addition, the machine room cover 51, together with the outer case 12, may form the exterior appearance of the refrigerator 1

Referring to FIGS. 2 to 4, the refrigerator 1 may include an insulating member 100. The insulating member 100 may be configured to insulate the storage compartment 20.

The insulating member 100 may be disposed between the inner case 11 and the outer case 12. Specifically, a spaced region S may be formed between the inner case 11 and the outer case 12, and the insulating member 100 may be disposed in the spaced region S.

The insulating member 100 may include an insulating panel 200 and an insulating material 300. The insulating material 300 may surround at least a portion of the insulating panel 200. In other words, the insulating panel 200 may be inserted into the insulating material 300.

The insulating panel 200 may be integrally formed with the insulating material 300. With such a configuration, the insulating member 100 may be modularized as a single component.

The insulating member 100 may be injection-molded. The insulating member 100 may be injection-molded by inserting the insulating panel 200 into the insulating material 300. Specifically, the insulating member 100 may be formed by inserting the insulating panel 200 into a mold, followed by injecting and curing the insulating material 300. With such a configuration, the insulating panel 200 and the insulating material 300 may be integrally formed.

Since the insulating member 100 is manufactured by injection molding, the insulating member 100 may be formed into any desired shape. For example, the insulating member 100 may be formed in a shape corresponding to a portion requiring insulation. Specifically, the insulating member 100 may be formed in a shape corresponding to at least a portion of the spaced region S. In other words, the insulating member 100 may be formed in a shape corresponding to all or part of the spaced region S.

The insulating member 100 may be disposed even in a portion having a complex shape in which insulation is required. For example, a corner portion of the refrigerator 1 (i.e., the space between the corner of the inner case 11 and the corner of the outer case 12) or the space between the storage compartment 20 and the machine room 50 may have a complex shape, but are portions in which insulation is required due to a risk of cold air leakage from the storage compartment 20. The insulating member 100 may be injection-molded to match the shape of such portions having complex shapes as described above and may be disposed in the portions.

In particular, when attempting to dispose only the insulating panel 200 at the corner portion of the refrigerator 1, the insulating panel 200 may fail to come into close contact with the inner case 11 or the outer case 12 due to design tolerances of the insulating panel 200. Moreover, because the insulating panel 200 has shape constraints, it may not be feasible to manufacture the insulating panel 200 in a shape corresponding to the corner portion of the refrigerator 1.

According to the concept of the present disclosure, the insulating member 100 may be disposed even at the corner portion of the refrigerator 1. Since the insulating member 100 may be injection-molded into a shape corresponding to the corner portion of the refrigerator 1, the insulating member 100 and the inner case 11, and the insulating member 100 and the outer case 12, may be closely coupled to each other. Accordingly, the corner portion of the refrigerator 1 may be more effectively insulated. Further details will be described later.

The insulating panel 200 may include a vacuum insulating panel 200. The vacuum insulating panel 200 may be configured to have low thermal conductivity using a vacuum state in which heat transfer is minimized. The vacuum insulating panel 200 may include a core material 200a and an outer covering material 200b disposed outside the core material 200a to form an accommodation space in which the core material 200a is received. The inside of the outer covering material 200b may be provided in a vacuum state or in a state close to vacuum.

The vacuum insulating panel 200 may have a lower thermal conductivity than the insulating material 300. For example, the minimum volume of the vacuum insulating panel 200 required to achieve a certain level of insulation performance may be smaller than the minimum volume of the insulating material 300 required to achieve the same level of insulation performance. Therefore, when the vacuum insulating panel 200 is disposed between the inner case 11 and the outer case 12 to insulate the storage compartment 20, the gap between the inner case 11 and the outer case 12 may be formed relatively smaller, and accordingly, the storage compartment 20 may be formed larger.

At least some of a plurality of the insulating panels 200 may be vacuum insulating panels 200. That is, some or all of the plurality of insulating panels 200 may be vacuum insulating panels 200. For convenience of description, the present specification will assume a case in which all of the plurality of insulating panels 200 are provided as vacuum insulating panels 200. Therefore, the insulating panel 200 and the vacuum insulating panel 200 may be referred to with the same reference numeral.

The insulating material 300 may include at least one of expanded polypropylene (EPP) or expanded polystyrene (EPS). However, the type of the insulating material 300 is not limited thereto. For example, the insulating material 300 may include urethane.

The insulating member 100 may be provided as a plurality of insulating members 100. Each of the plurality of insulating members 100 may be disposed in the spaced region S. However, there is no particular limitation on the number of the insulating members 100, and an embodiment in which only one insulating member 100 is provided is also possible.

The refrigerator 1 may include an auxiliary insulating material 400. The auxiliary insulating material 400 may be configured to insulate the storage compartment 20 together with the insulating member 100.

The auxiliary insulating material 400 may be disposed in the spaced region S. At least a portion of the auxiliary insulating material 400 may contact the insulating member 100.

Specifically, the insulating member 100 may be disposed in one portion of the spaced region S, and the auxiliary insulating material 400 may be disposed in another portion of the spaced region S. For example, the insulating member 100 may be provided as a plurality of insulating members 100, and at least a portion of the auxiliary insulating material 400 may be disposed between the plurality of insulating members 100. With such a configuration, the entire spaced region S may be completely filled with the insulating member 100 and the auxiliary insulating material 400.

The auxiliary insulating material 400 may be formed by foaming in the spaced region S. Specifically, after the insulating member 100 is installed in the spaced region S, the auxiliary insulating material 400 may be foamed in the spaced region S. For example, the auxiliary insulating material 400 may include urethane

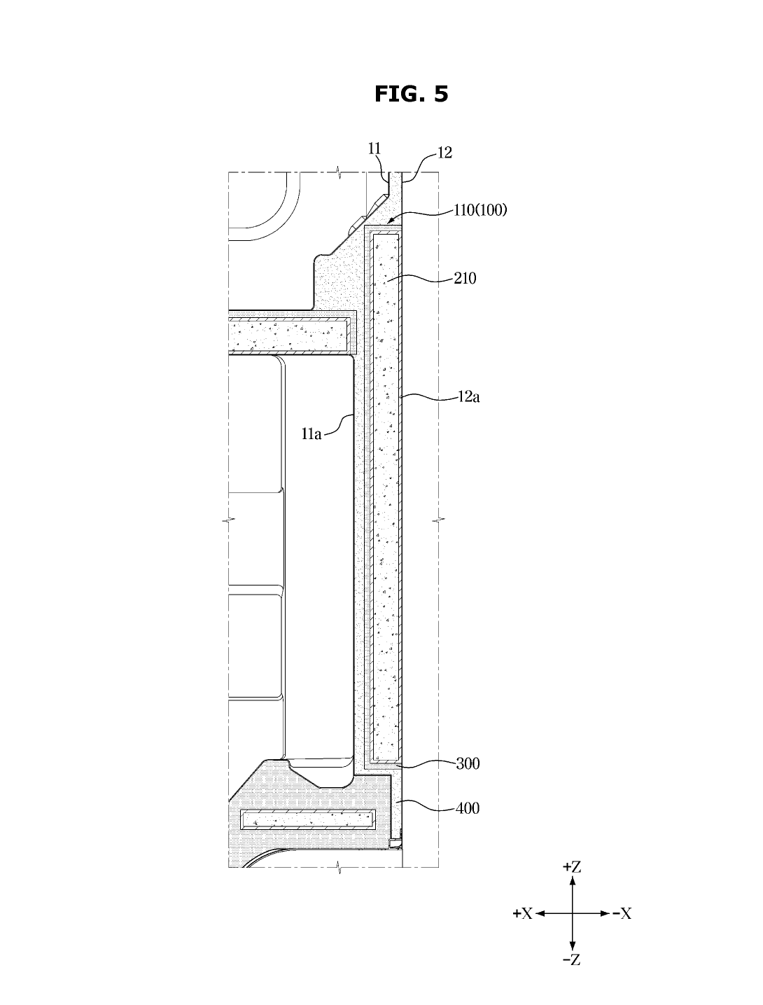

Hereinafter, a first insulating member 110, a second insulating member 120, and a third insulating member 130 among the plurality of insulating members 100 will be described with reference to FIGS. 5 to 13. However, each of the first insulating member 110, the second insulating member 120, and the third insulating member 130 is merely one embodiment of the insulating member 100 according to the present disclosure, and the shape or position of the insulating member 100 is not limited to those of the first insulating member 110, the second insulating member 120, and the third insulating member 130. That is, depending on the embodiment, the shape or position of each of the plurality of insulating members 100 may vary.

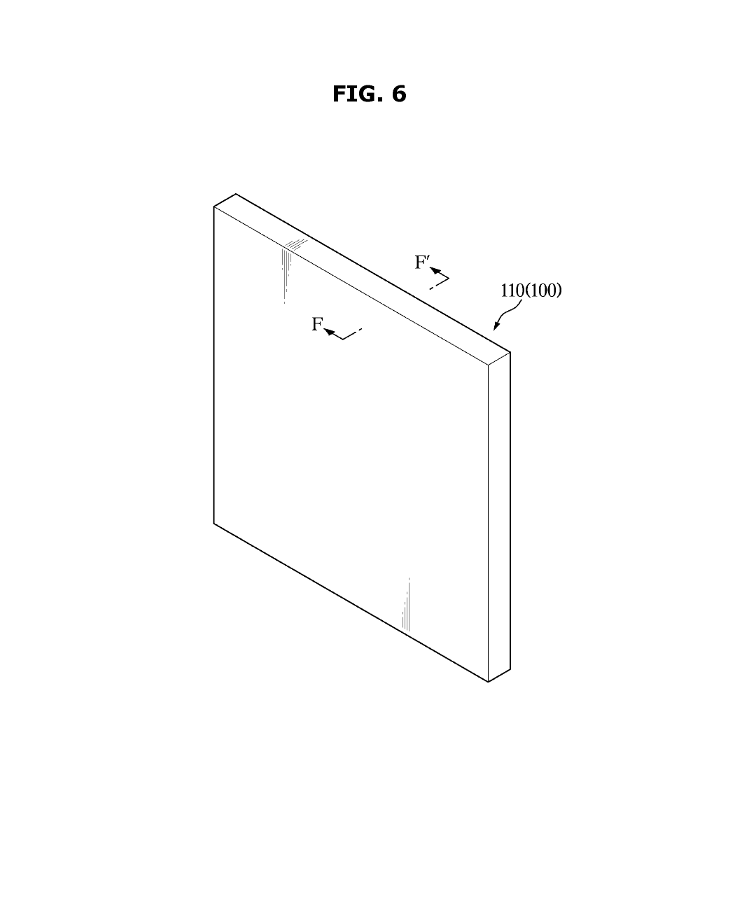

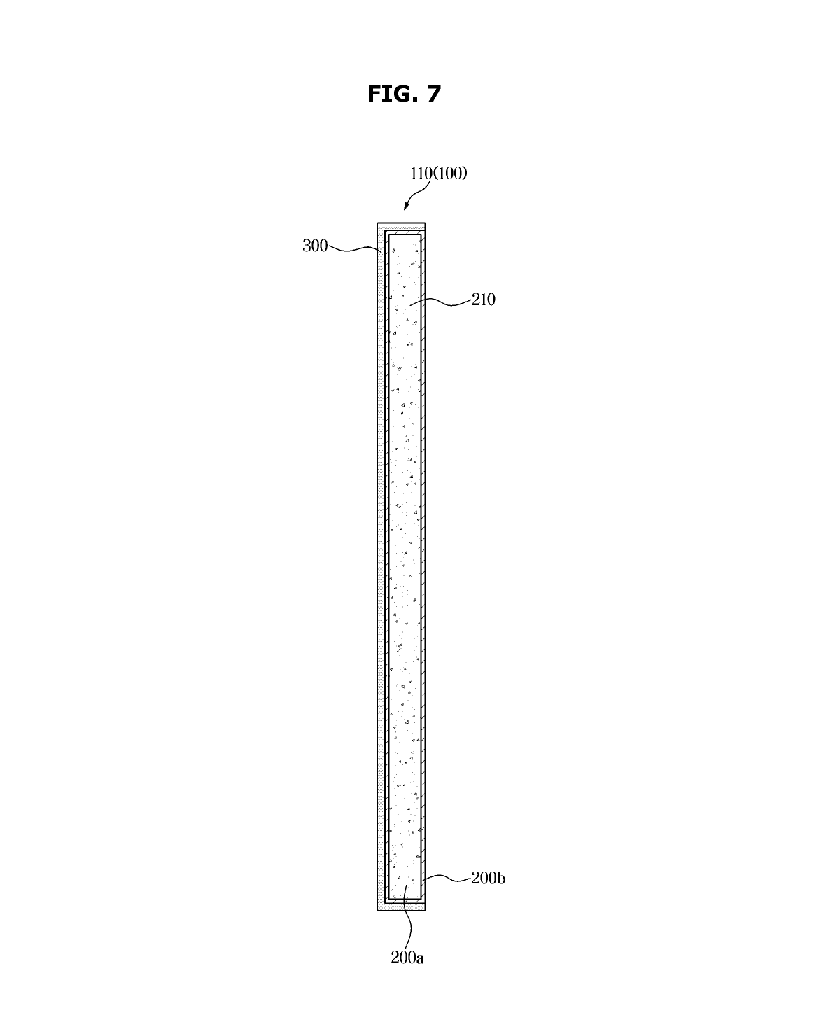

FIG. 5 is an enlarged view of region C shown in FIG. 2. FIG. 6 is a perspective view illustrating a first insulating member according to an embodiment. FIG. 7 is a cross-sectional view taken along line F-F′ shown in FIG. 6.

Referring to FIGS. 5 to 7, the plurality of insulating members 100 may include the first insulating member 110. The first insulating member 110 may be disposed between a rear wall 11a (–X direction) of the inner case 11 and a rear wall 12a (–X direction) of the outer case 12. Accordingly, the first insulating member 110 may insulate the storage compartment 20 from an external space of the refrigerator 1.

The first insulating member 110 may be formed in a shape corresponding to the space between the rear wall 11a of the inner case 11 and the rear wall 12a of the outer case 12. For example, the first insulating member 110 may be provided in a substantially hexahedral shape.

Although the drawings illustrate each surface of the first insulating member 110 as being formed flat, the shape of each surface of the first insulating member 110 is not limited thereto. For example, the rear wall 11a of the inner case 11 and the rear wall 12a of the outer case 12 may each have a complex structure such as uneven portions, protrusions, bent portions, or grooves, and each surface of the first insulating member 110 may be correspondingly formed into a complex shape.

A first insulating panel 210 may be provided inside the first insulating member 110. In this case, the first insulating panel 210 may have substantially the same configuration as the insulating panel 200 described with reference to FIGS. 2 to 4.

The insulating material 300 may surround at least a portion of the first insulating panel 210. The first insulating panel 210 may be integrally formed with the insulating material 300. Through such a configuration, the first insulating member 110 may be modularized as a single component.

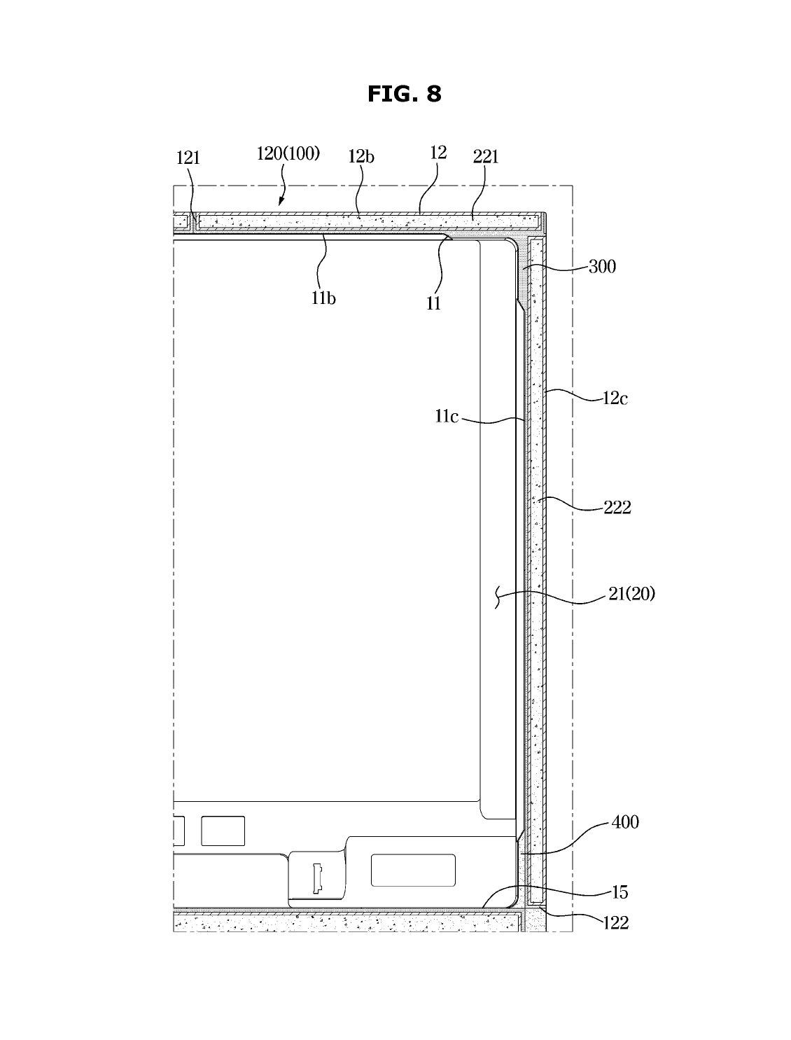

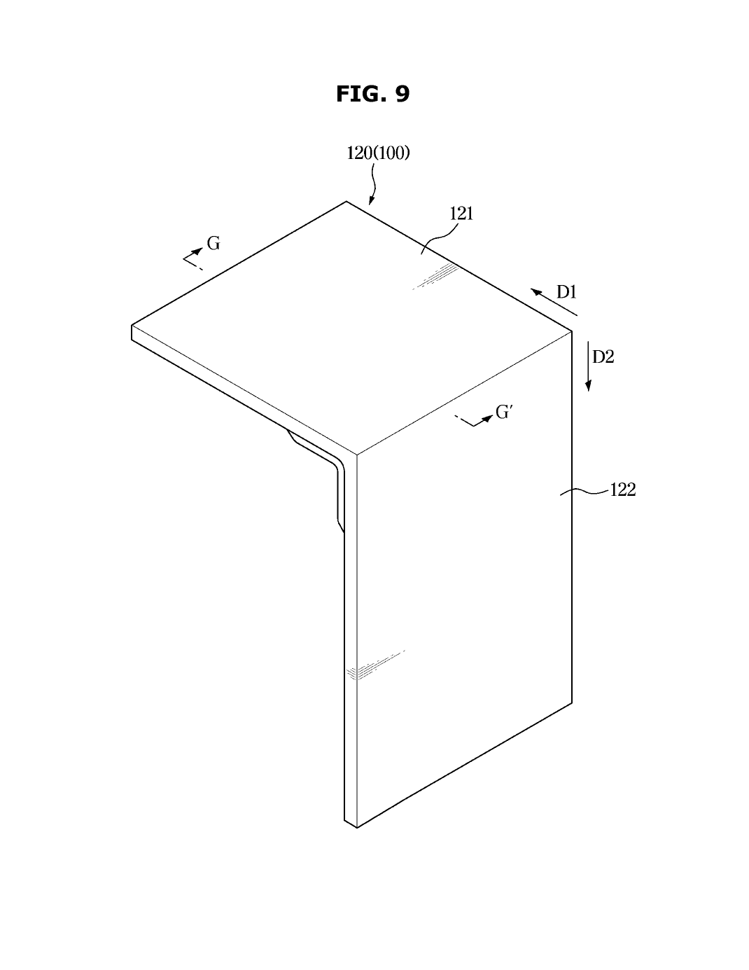

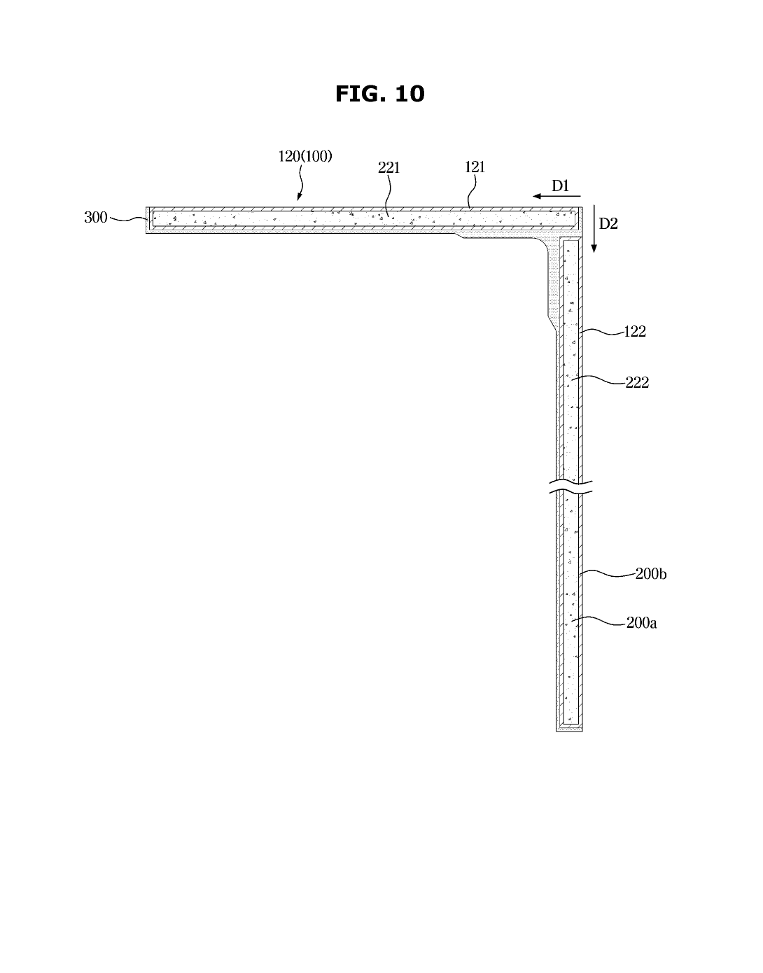

FIG. 8 is an enlarged view of region E shown in FIG. 3. FIG. 9 is a perspective view illustrating a second insulating member according to an embodiment. FIG. 10 is a cross-sectional view taken along line G-G′ shown in FIG. 9.

Referring to FIGS. 8 to 10, the plurality of insulating members 100 may include the second insulating member 120. The second insulating member 120 may be disposed between a corner portion of the inner case 11 and a corner portion of the outer case 12. Specifically, one portion of the second insulating member 120 may be disposed between a first sidewall 11b of the inner case 11 and a first sidewall 12b of the outer case 12, and another portion of the second insulating member 120 may be disposed between a second sidewall 11c bent from the first sidewall 11b of the inner case 11 and a second sidewall 12c bent from the first sidewall 12b of the outer case 12. For example, the first sidewall 11b of the inner case 11 and the first sidewall 12b of the outer case 12 may each be an upper wall (+Z direction), and the second sidewall 11c of the inner case 11 and the second sidewall 12c of the outer case 12 may each be a left wall (+Y direction). Accordingly, the second insulating member 120 may be disposed at the corner portion of the refrigerator 1, to insulate the storage compartment 20 from the external space of the refrigerator 1.

The second insulating member 120 may include a first extension part 121 extending in a first direction D1, and a second extension part 122 bent from the first extension part 121 and extending in a direction different from the first direction D1. For example, the first direction D1 and a second direction D2 may be perpendicular to each other.

The first extension part 121 may be disposed between the first sidewall 11b of the inner case 11 and the first sidewall 12b of the outer case 12. For example, the first extension part 121 may be disposed between the upper wall of the inner case 11 and the upper wall of the outer case 12. The first extension part 121 may extend in the direction in which the first sidewall 11b of the inner case 11 or the first sidewall 12b of the outer case 12 extends. For example, the first extension part 121 may extend in the left–right direction (Y-axis direction). In this case, the space between the first sidewall 11b of the inner case 11 and the first sidewall 12b of the outer case 12 may also be referred to as “between the first sidewall 11b of the inner case 11 and the outer case 12” or “between the first sidewall 12b of the outer case 12 and the inner case 11.”

The second extension part 122 may be disposed between the second sidewall 11c of the inner case 11 and the second sidewall 12c of the outer case 12. For example, the second extension part 122 may be disposed between the left wall of the inner case 11 and the left wall of the outer case 12. The second extension part 122 may extend in the direction in which the second sidewall 11c of the inner case 11 or the second sidewall 12c of the outer case 12 extends. For example, the second extension part 122 may extend in the upper-lower direction (Z-axis direction). In this case, the space between the second sidewall 11c of the inner case 11 and the second sidewall 12c of the outer case 12 may also be referred to as “between the second sidewall 11c of the inner case 11 and the outer case 12” or “between the second sidewall 12c of the outer case 12 and the inner case 11.”

That is, the second insulating member 120 may be formed in a shape corresponding to the space between the corner portion of the inner case 11 and the corner portion of the outer case 12.

A plurality of insulating panels 221 and 222 may be provided inside the second insulating member 120. Specifically, the plurality of insulating panels 221 and 222 may include a second insulating panel 221 and a third insulating panel 222. In this case, each of the second insulating panel 221 and the third insulating panel 222 may have substantially the same configuration as the insulating panel 200 described with reference to FIGS. 2 to 4.

At least a portion of the second insulating panel 221 may be provided in the first extension part 121. The second insulating panel 221 may extend in a direction in which the first extension part 121 extends. For example, the second insulating panel 221 may extend in the left–right direction (Y-axis direction).

At least a portion of the third insulating panel 222 may be provided in the second extension part 122. The third insulating panel 222 may extend in a direction in which the second extension part 122 extends. For example, the third insulating panel 222 may extend in the upper-lower direction (Z-axis direction).

The insulating material 300 may surround at least a portion of the second insulating panel 221 and the third insulating panel 222. The second insulating panel 221 and the third insulating panel 222 may be integrally formed with the insulating material 300. Through such a configuration, the second insulating member 120 may be modularized as a single component.

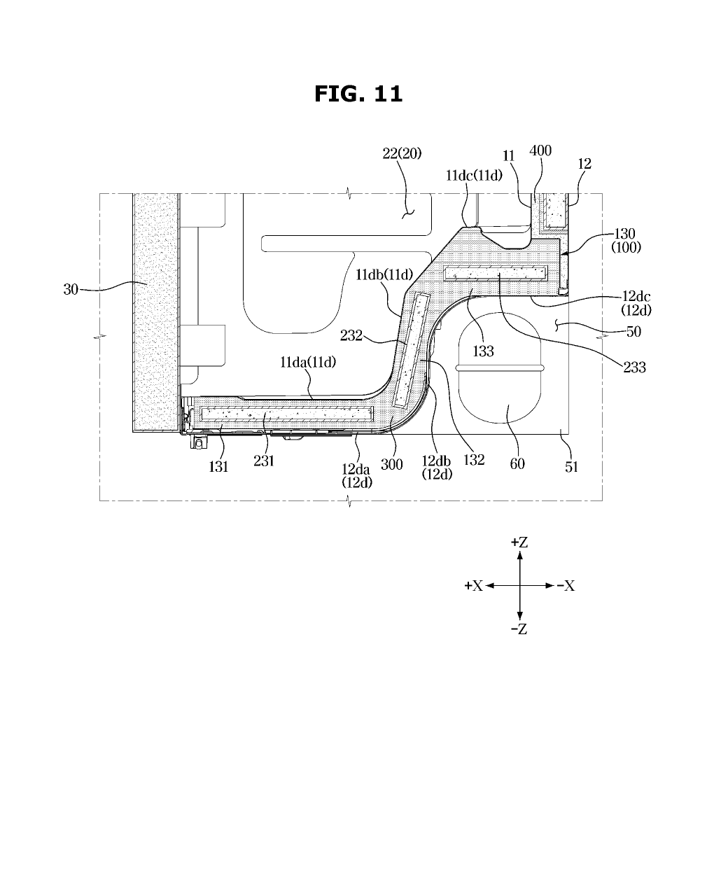

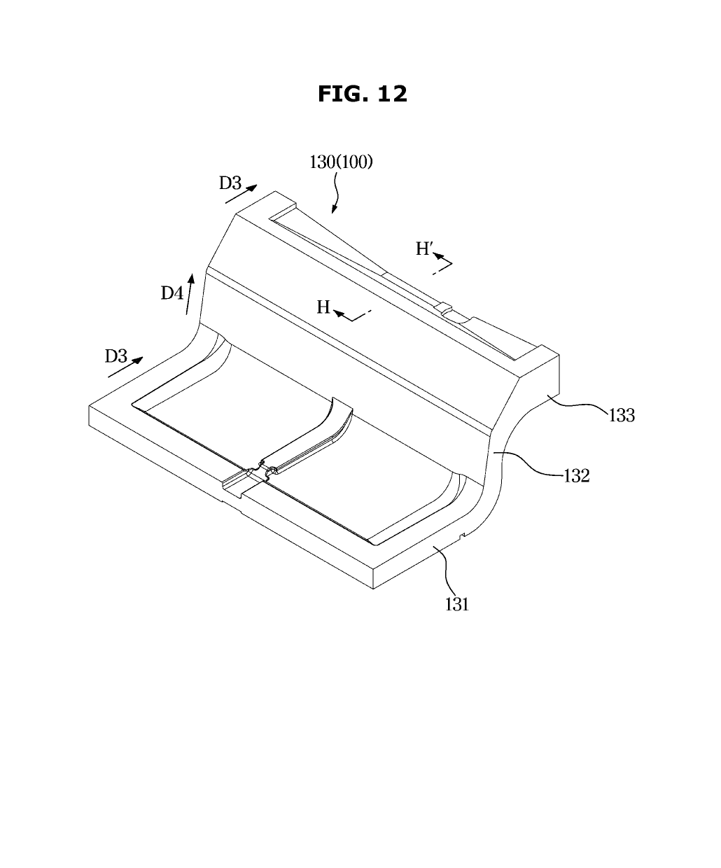

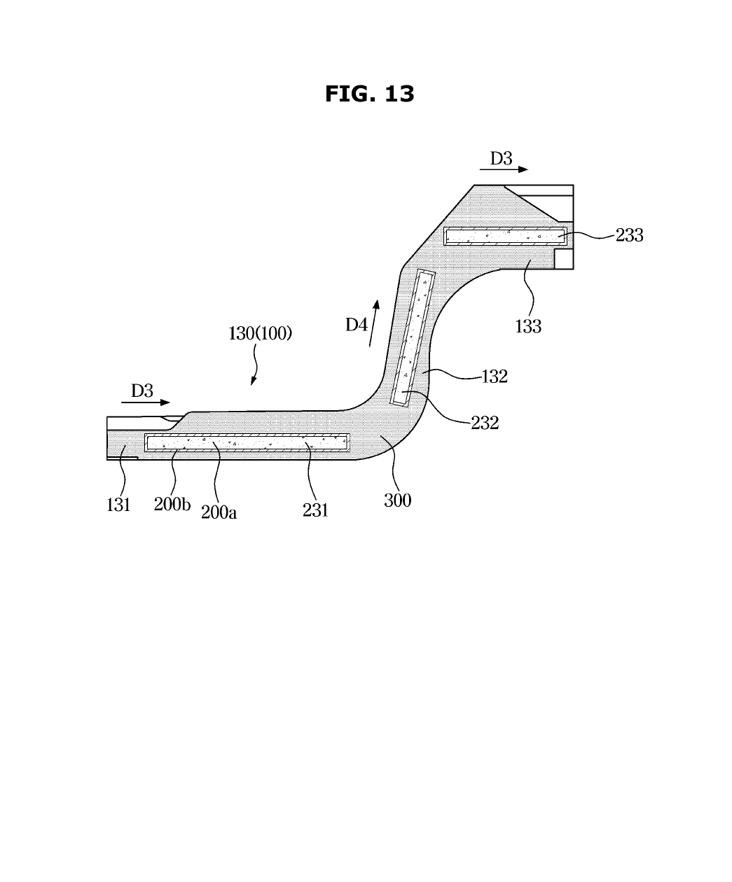

FIG. 11 is an enlarged view of region D shown in FIG. 2. FIG. 12 is a perspective view illustrating a third insulating member according to an embodiment. FIG. 13 is a cross-sectional view taken along line H-H′ shown in FIG. 12.

Referring to FIGS. 11 to 13, the plurality of insulating members 100 may include a third insulating member 130. The third insulating member 130 may be disposed between a lower wall 11d (the –Z direction) of the inner case 11 and a lower wall 12d (–Z direction) of the outer case 12. Accordingly, the third insulating member 130 may insulate the storage compartment 20 from an external space of the refrigerator 1.

Specifically, the lower wall 11d of the inner case 11 may include a first horizontal portion 11da extending substantially parallel to the ground, a first bent portion 11db bent from the first horizontal portion 11da and extending upward, and a second horizontal portion 11dc bent from the first bent portion 11db and extending substantially parallel to the ground. In addition, the lower wall 12d of the outer case 12 may include a third horizontal portion 12da extending substantially parallel to the ground, a second bent portion 12db bent from the third horizontal portion 12da and extending upward, and a fourth horizontal portion 12dc bent from the second bent portion 12db and extending substantially parallel to the ground.

One portion of the third insulating member 130 may be disposed between the first horizontal portion 11da of the inner case 11 and the third horizontal portion 12da of the outer case 12. Another portion of the third insulating member 130 may be disposed between the first bent portion 11db of the inner case 11 and the second bent portion 12db of the outer case 12. Still another portion of the third insulating member 130 may be disposed between the second horizontal portion 11dc of the inner case 11 and the fourth horizontal portion 12dc of the outer case 12.

At least a portion of the third insulating member 130 may be provided between the storage compartment 20 and the machine room 50. Specifically, the first bent portion 11db and the second horizontal portion 11dc of the inner case 11 may, together with other sidewalls of the inner case 11, form the storage compartment 20, and the second bent portion 12db and the fourth horizontal portion 12dc of the outer case 12 may, together with the machine room cover 51, form the machine room 50. By being disposed between the first bent portion 11db and the second horizontal portion 11dc of the inner case 11 and the second bent portion 12db and the fourth horizontal portion 12dc of the outer case 12, the at least a portion of the third insulating member 130 may be provided between the storage compartment 20 and the machine room 50. Accordingly, the third insulating member 130 may insulate the storage compartment 20 from the machine room 50.

The third insulating member 130 may include a third extension part 131 extending in a third direction D3, a fourth extension part 132 bent from the third extension part 131 and extending in a fourth direction D4 different from the third direction D3, and a fifth extension part 133 bent from the fourth extension part 132 and extending in the same direction as the third direction D3.

The third extension part 131 may be disposed between the first horizontal portion 11da of the inner case 11 and the third horizontal portion 12da of the outer case 12. The third extension part 131 may extend in a direction in which the first horizontal portion 11da of the inner case 11 or the third horizontal portion 12da of the outer case 12 extends. For example, the third extension part 131 may extend in the front–rear direction (X-axis direction).

The fourth extension part 132 may be disposed between the first bent portion 11db of the inner case 11 and the second bent portion 12db of the outer case 12. The fourth extension part 132 may extend in a direction in which the first bent portion 11db of the inner case 11 or the second bent portion 12db of the outer case 12 extends.

The fifth extension part 133 may be disposed between the second horizontal portion 11dc of the inner case 11 and the fourth horizontal portion 12dc of the outer case 12. The fifth extension part 133 may extend in a direction in which the second horizontal portion 11dc of the inner case 11 or the fourth horizontal portion 12dc of the outer case 12 extends. For example, the fifth extension part 133 may extend in the front–rear direction (X-axis direction).

That is, the third insulating member 130 may be formed in a shape corresponding to the space between the lower wall 11d of the inner case 11 and the lower wall 12d of the outer case 12.

A plurality of insulating panels 231, 232, and 233 may be provided inside the third insulating member 130. Specifically, the plurality of insulating panels 231, 232, and 233 may include a fourth insulating panel 231, a fifth insulating panel 232, and a sixth insulating panel 233. In this case, each of the fourth insulating panel 231, the fifth insulating panel 232, and the sixth insulating panel 233 may have substantially the same configuration as the insulating panel 200 described with reference to FIGS. 2 to 4.

At least a portion of the fourth insulating panel 231 may be provided in the third extension part 131. The fourth insulating panel 231 may extend in the direction in which the third extension part 131 extends. For example, the fourth insulating panel 231 may extend in the front–rear direction (X-axis direction).

At least a portion of the fifth insulating panel 232 may be provided in the fourth extension part 132. The fifth insulating panel 232 may extend in the direction in which the fourth extension part 132 extends.

At least a portion of the sixth insulating panel 233 may be provided in the fifth extension part 133. The sixth insulating panel 233 may extend in the direction in which the fifth extension part 133 extends. For example, the sixth insulating panel 233 may extend in the front–rear direction (X-axis direction).

The insulating material 300 may surround at least a portion of the fourth insulating panel 231, the fifth insulating panel 232, and the sixth insulating panel 233. The fourth insulating panel 231, the fifth insulating panel 232, and the sixth insulating panel 233 may be integrally formed with the insulating material 300. Through such a configuration, the third insulating member 130 may be modularized as a single component.

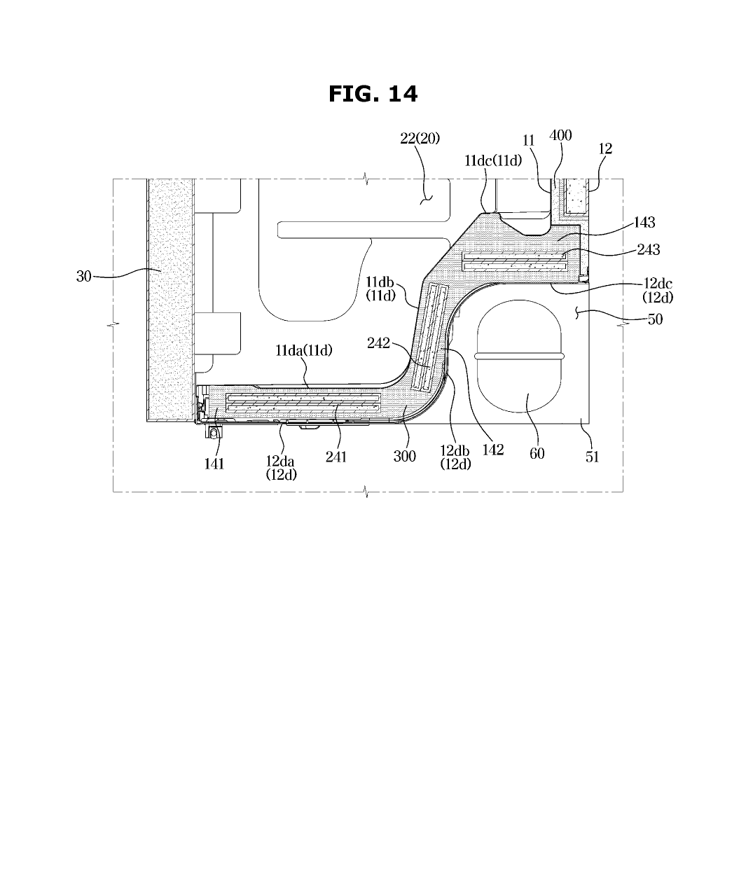

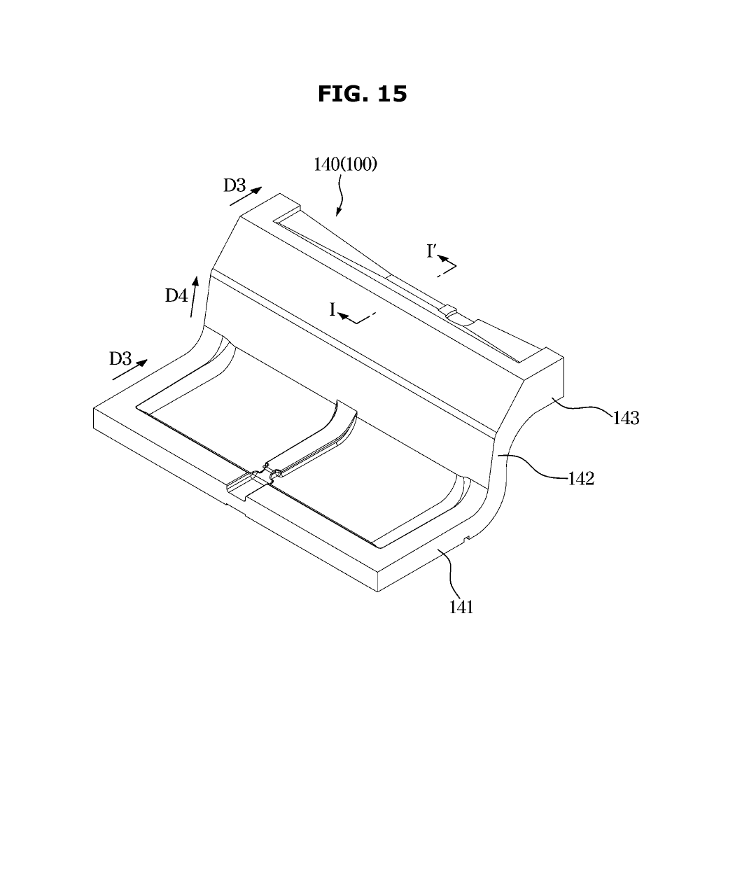

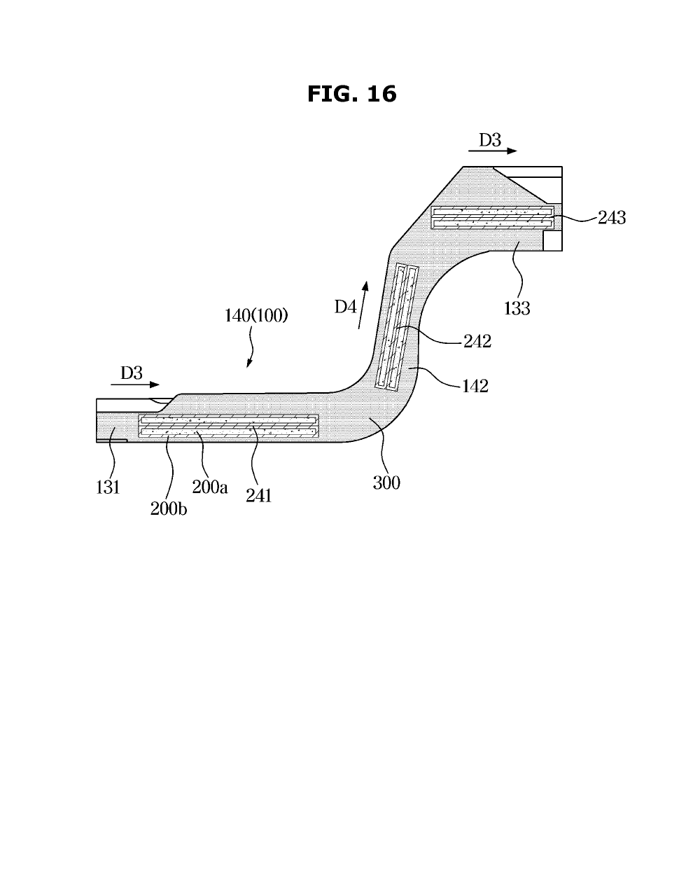

FIG. 14 is an enlarged view of a portion of a cross-section of the refrigerator according to an embodiment. FIG. 15 is a view illustrating a fourth insulating member according to an embodiment. FIG. 16 is a cross-sectional view taken along line I-I′ shown in FIG. 15.

Hereinafter, with reference to FIGS. 14 to 16, a fourth insulating member 140 according to one embodiment of the present disclosure will be described. In describing the fourth insulating member 140, components that are substantially the same as those illustrated in FIGS. 1 to 4, and FIGS. 11 to 13 are given the same reference numerals, and a detailed description thereof may be omitted.

Referring to FIGS. 14 to 16, the plurality of insulating members 100 may include a fourth insulating member 140. The fourth insulating member 140 may have the same shape as the third insulating member 130 described with reference to FIGS. 11 to 13.

For example, the fourth insulating member 140 may include a sixth extension part 141 extending in a third direction D3, a seventh extension part 142 bent from the sixth extension part 141 and extending in a direction different from the third direction D3, and an eighth extension part 143 bent from the seventh extension part 142 and extending in the same direction as the third direction D3. The sixth extension part 141 may be disposed between the first horizontal portion 11da of the inner case 11 and the third horizontal portion 12da of the outer case 12, the seventh extension part 142 may be disposed between the first bent portion 11db of the inner case 11 and the second bent portion 12db of the outer case 12, and the eighth extension part 143 may be disposed between the second horizontal portion 11dc of the inner case 11 and the fourth horizontal portion 12dc of the outer case 12.

That is, the fourth insulating member 140 may be formed in a shape corresponding to the space between the lower wall 11d of the inner case 11 and the lower wall 12d of the outer case 12.

A plurality of insulating panels 241, 242, and 243 may be provided inside the fourth insulating member 140. Specifically, the plurality of insulating panels 241, 242, and 243 may include a seventh insulating panel 241, an eighth insulating panel 242, and a ninth insulating panel 243. Each of the seventh insulating panel 241, the eighth insulating panel 242, and the ninth insulating panel 243 may have substantially the same configuration as the insulating panel 200 described with reference to FIGS. 2 to 4.

At least a portion of the seventh insulating panel 241 may be disposed within the sixth extension part 141. At least a portion of the eighth insulating panel 242 may be disposed within the seventh extension part 142. At least a portion of the ninth insulating panel 243 may be disposed within the eighth extension part 143.

At least some of the plurality of insulating panels 241, 242, and 243 may be stacked in a direction intersecting the extension direction of the fourth insulating member 140. In other words, at least some of the plurality of insulating panels 241, 242, and 243 may be stacked in a direction intersecting one of a direction in which the sixth extension part 141 extends, a direction in which the seventh extension part 142 extends, and a direction in which the eighth extension part 143 extends.

For example, the seventh insulating panel 241 may be provided as a plurality of seventh insulating panels 241, and the plurality of seventh insulating panels 241 may be stacked in a direction intersecting the extension direction of the sixth extension part 141. For instance, the plurality of seventh insulating panels 241 may be stacked in the upper-lower direction (Z direction). Although only two seventh insulating panels 241 are illustrated in the drawings, the number of seventh insulating panels 241 is not particularly limited.

For example, the eighth insulating panel 242 may be provided as a plurality of eighth insulating panels 242, and the plurality of eighth insulating panels 242 may be stacked in a direction intersecting the extension direction of the seventh extension part 142. Although only two eighth insulating panels 242 are illustrated in the drawings, the number of eighth insulating panels 242 is not particularly limited.

For example, the ninth insulating panel 243 may be provided as a plurality of ninth insulating panels 243, and the plurality of ninth insulating panels 243 may be stacked in a direction intersecting the extension direction of the eighth extension part 143. For example, the plurality of ninth insulating panels 243 may be stacked in the upper-lower direction (Z direction). Although only two ninth insulating panels 243 are illustrated in the drawings, the number of ninth insulating panels 243 is not particularly limited.

Through such a configuration, a larger number of insulating panels 241, 242, and 243 may be disposed between the lower wall 11d of the inner case 11 and the lower wall 12d of the outer case 12. Accordingly, the insulation efficiency between the storage compartment 20 and the external space of the refrigerator 1, as well as the insulation efficiency between the storage compartment 20 and the machine room 50, may be relatively enhanced.

In particular, since the machine room 50 may accommodate a cold air supply device such as a compressor 60 or a condenser (not shown), the interior of the machine room 50 may be at a relatively high temperature. Thus, heat may be more easily transferred between the storage compartment 20 and the machine room 50.

According to the spirit of the present disclosure, by stacking at least some of the plurality of insulating panels 241, 242, and 243 between the lower wall 11d of the inner case 11 and the lower wall 12d of the outer case 12, heat transfer between the storage compartment 20 and the machine room 50 may be more effectively suppressed.

The insulating material 300 may surround at least a portion of the seventh insulating panel 241, the eighth insulating panel 242, and the ninth insulating panel 243. The seventh insulating panel 241, the eighth insulating panel 242, and the ninth insulating panel 243 may be integrally formed with the insulating material 300. Through such a configuration, the fourth insulating member 140 may be modularized as a single component.

Hereinafter, a method 1000 of manufacturing a refrigerator 1 according to the present disclosure will be described with reference to FIGS. 1 to 13 and FIG. 17.

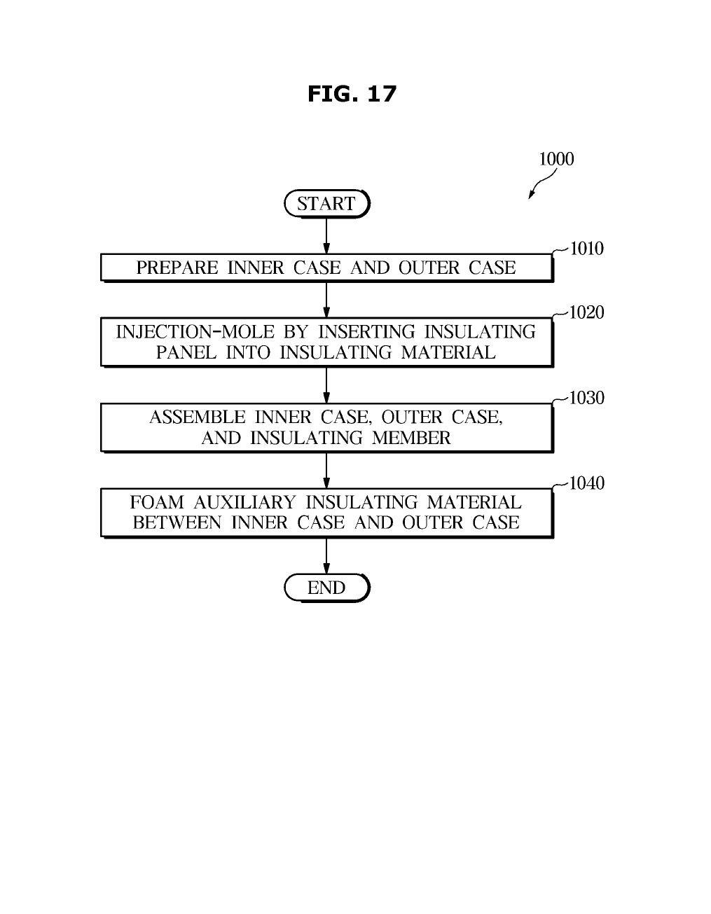

FIG. 17 is a block diagram illustrating a method of manufacturing a refrigerator according to an embodiment.

Referring to FIGS. 1 to 13 and FIG. 17, first, an inner case 11 and an outer case 12 may be prepared 1010. The inner case 11 may be formed by injection molding with a plastic material, and the outer case 12 may be formed of a metal material. For example, the inner case 11 may be manufactured through a vacuum forming process or an injection molding process. For example, the outer case 12 may be manufactured by processing a steel sheet material.

Subsequently, an insulating panel 200 may be inserted into an insulating material 300 to injection-mold an insulating member 100, 1020. Accordingly, the insulating material 300 may surround at least a portion of the insulating panel 200. In addition, the insulating panel 200 may be integrally formed with the insulating material 300. That is, the insulating member 100 may be modularized as a single component.

For example, a first insulating member 110 may be injection-molded by inserting a first insulating panel 210 into an insulating material 300. For example, a second insulating member 120 may be injection-molded by inserting a second insulating panel 221 and a third insulating panel 222 into an insulating material 300. For example, a third insulating member 130 may be injection-molded by inserting a fourth insulating panel 231, a fifth insulating panel 232, and a sixth insulating panel 233 into an insulating material 300.

When the inner case 11 and the outer case 12 are coupled to each other, a spaced region S in which the insulating member 100 may be disposed may be formed between the inner case 11 and the outer case 12. The insulating member 100 may be injection-molded in a shape corresponding to at least a portion of the spaced region S.

For example, the first insulating member 110 may be injection-molded in a shape corresponding to the space between the rear wall 11a of the inner case 11 and the rear wall 12a of the outer case 12. For example, the second insulating member 120 may be injection-molded in a shape corresponding to the space between the corner portion of the inner case 11 and the corner portion of the outer case 12. For example, the third insulating member 130 may be injection-molded in a shape corresponding to the space between the lower wall 11d of the inner case 11 and the lower wall 12d of the outer case 12.

Subsequently, the inner case 11, the outer case 12, and the insulating member 100 may be assembled 1030. In this case, the insulating member 100 may be disposed in the spaced region S between the inner case 11 and the outer case 12.

For example, the first insulating member 110 may be disposed between the rear wall 11a of the inner case 11 and the rear wall 12a of the outer case 12. For example, the second insulating member 120 may be disposed between the corner portion of the inner case 11 and the corner portion of the outer case 12. The third insulating member 130 may be disposed between the lower wall 11d of the inner case 11 and the lower wall 12d of the outer case 12.

Subsequently, an auxiliary insulating material 400 may be foamed between the inner case 11 and the outer case 121040. In other words, the auxiliary insulating material 400 may be foamed in the spaced region S. Specifically, the insulating member 100 may be disposed in a portion of the spaced region S, and the auxiliary insulating material 400 may be foamed in another portion of the spaced region S. That is, after the insulating member 100 is disposed in the spaced region S, the auxiliary insulating material 400 may be foamed in the remaining portion of the spaced region S. The auxiliary insulating material 400, together with the insulating member 100, may insulate the storage compartment 20.

For example, the insulating member 100 may be provided as a plurality of insulating members 100, and at least a portion of the auxiliary insulating material 400 may be foamed between the plurality of insulating members 100. Through such a manufacturing method, the entire spaced region S may be completely filled with the insulating member 100 and the auxiliary insulating material 400.

Generally, when the spaced region S between the inner case 11 and the outer case 12 is filled only with an insulating material such as urethane, a complicated process is required. For example, a foaming jig needs to be installed for stable foaming of an insulating material, and a curing process of the insulating material may be accompanied after the foaming. In addition, during the foaming and curing process, post-deformation of the insulating material may occur, potentially reducing the insulating performance of the insulating material.

According to the spirit of the present disclosure, by disposing a modularized insulating member 100 together with the auxiliary insulating material 400 in the spaced region S between the inner case 11 and the outer case 12, the manufacturing process of the refrigerator 1 may be simplified. In particular, since the process of disposing the insulating member 100 in the spaced region S does not require equipment such as a foaming jig, the manufacturing cost of the refrigerator 1 may be further reduced. In addition, even when the shape of the refrigerator 1 is partially changed, there is no need to replace or modify the manufacturing equipment, so the design of the refrigerator 1 may be relatively freely changed. That is, the assembly capability of the refrigerator 1 may be further improved.

According to the spirit of the present disclosure, the auxiliary insulating material 400 may be foamed in the remaining portion of the spaced region S after the insulating member 100 is disposed in the spaced region S, so the total volume of the portion in which the auxiliary insulating material 400 is foamed may be relatively small. Furthermore, the portion in which the auxiliary insulating material 400 is foamed may not be concentrated in a single region but may be dispersed in a plurality of locations across the entire spaced region S. Accordingly, the auxiliary insulating material 400 may fill the spaced region S by foaming a relatively small amount of the auxiliary insulating material 400 at a plurality of points in the spaced region S, thereby preventing post-deformation of the auxiliary insulating material 400 as the amount of the auxiliary insulating material 400 foamed at each portion is relatively reduced.

A refrigerator 1 according to an embodiment includes: an inner case 11 having a storage compartment therein; an outer case 12 outside the inner case 11; and an injection molded insulating member 100 in a spaced region S between the inner case 11 and the outer case 12, the injection molded insulating member 100 including an insulating panel 200 and an insulating material 300 integrally formed together. The insulating material 300 surrounds at least a portion of the insulating panel 200.

The injection molded insulating member 120 may include: a first extension portion 121 extending in one direction D1; and a second extension portion 122 extending from the first extension portion 121 in a direction D2 different from the one direction.

The insulating panel 221, 222 may include: a first insulating panel 221 having at least a portion within the first extension portion 121 and extending along a direction in which the first extension portion 121 extends; and a second insulating panel 222 having at least a portion within the second extension portion 122 and extending along a direction in which the second extension portion 122 extends.

The outer case 12 may include: a first sidewall 12b; and a second sidewall 12c extending from the first sidewall. The first extension portion 121 may extend between the first sidewall 12b and the inner case 11, and the first extension portion 121 and the first sidewall 12b extend in a same direction. The second extension portion 122 may extend between the second sidewall 12c and the inner case 11, and the second extension portion 122 and the second sidewall 12c extend in a same direction.

The refrigerator 1 may further include: a machine room 50 outside the outer case 12 accommodating a device configured to supply cold air to the storage compartment. At least a portion of the injection molded insulating member 100 may be between the storage compartment 20 and the machine room 50.

The insulating material 300 may be a first insulating material 300. The injection molded insulating member 100 may be in a portion of the spaced region S. The refrigerator may further include a foamed second insulating material 400 in another portion of the spaced region S. The foamed second insulating material 400 is in contact with the injection molded insulating member 100 such that the foamed second insulating material 400 and the injection molded insulating member 100 insulate the storage compartment 20.

The injection molded insulating member 100 may include a plurality of injection molded insulating members. At least a portion of the second insulating material 400 may be between the plurality of injection molded insulating members 100.

The insulating panel 200 may include a vacuum insulating panel 200. The vacuum insulating panel 200 may include a core material 200a and an outer covering material 200b on an outer side of the core material, the outer covering material 200b forming an accommodation space to accommodate the core material 200a therewithin.

The insulating material 300 may include at least one of expanded polypropylene or expanded polystyrene.

The insulating panel 241, 242, and 243 may include a plurality of insulating panels. At least some of the plurality of insulating panels 241, 242, and 243 may be stacked in a direction that is not parallel to a longitudinal direction in which the injection molded insulating member 100 extends.

A refrigerator 1 according to one embodiment includes: an inner case 11 having a storage compartment 20 provided therein; an outer case 12 provided outside of the inner case 11; an insulating member 100 provided in a portion of a spaced region S between the inner case 11 and the outer case 12, the insulating member 100 including an insulating panel 200 and a first insulating material 300 into which the insulating panel 200 is inserted; and a second insulating material 400 provided in another portion of the spaced region S and in contact with at least a portion of the insulating member 100.

The insulating member 100 may be injection-molded in a shape corresponding to at least a portion of the spaced region S.

At least a portion of the second insulating material 400 may be formed by foaming in another portion of the spaced region S.

The insulating member 100 may be provided as a plurality of insulating members 100, and the second insulating material 400 may be provided between the plurality of insulating members 100.

The insulating member 120 may include a first extension portion 121 extending in one direction D1, and a second extension portion 122 bent from the first extension portion 121 and extending in a direction D2 different from the one direction D1.

The insulating panel 221, 222 may be provided as a plurality of insulating panels. The plurality of insulating panels 221 and 222 may include: a first insulating panel 221, at least a portion of which is provided in the first extension portion 121 and which extends along a direction in which the first extension portion 121 extends; and a second insulating panel 222, at least a portion of which is provided in the second extension portion 122 and which extends along a direction in which the second extension portion 122 extends.

A method 1000 of manufacturing a refrigerator 1 according to one embodiment includes: preparing an inner case 11 in which a storage compartment 20 is provided and an outer case 12 that may be provided outside of the inner case 11 1010; injection-molding an insulating member 100 by inserting the insulating panel 200 into the insulating material 300 such that the insulating material 300 surrounds at least a portion of the insulating panel 200, 1020; and assembling the inner case 11, the outer case 12, and the insulating member 100 such that the insulating member 100 is disposed between the inner case 11 and the outer case 12, 1030.

A spaced region S in which the insulating member 100 may be disposed may be formed between the inner case 11 and the outer case 12. The operation 1020 of injection-molding the insulating member 100 by inserting the insulating panel 200 into the insulating material 300 may include injection-molding the insulating member 100 in a shape corresponding to at least a portion of the spaced region S.

The insulating material 300 may be a first insulating material 300. The operation 1030 of assembling the inner case 11, the outer case 12, and the insulating member 100 may include disposing the insulating member 100 in a portion of the spaced region S. The method 1000 of manufacturing a refrigerator 1 may further include foaming a second insulating material 400 in another portion of the spaced region S such that the second insulating material together with the insulating member 100 insulates the storage compartment 20, 1040.

The insulating member 100 may be provided as a plurality of insulating members 100. The operation 1040 of foaming the second insulating material 400 in another portion of the spaced region S may include foaming at least a portion of the second insulating material 400 between the plurality of insulating members 100.

According to the spirit of the present disclosure, an insulating member of a refrigerator may be injection-molded by inserting an insulating panel into an insulating material.

According to the spirit of the present disclosure, the insulating member may be manufactured by injection molding in a shape corresponding to a portion requiring insulation. Accordingly, even when the portion requiring insulation has a complex shape, the insulating member may be disposed in that portion.

According to the spirit of the present disclosure, the insulating member of the refrigerator may be modularized through injection molding. Therefore, the assembly capability of the refrigerator may be further improved.

The effects of the disclosure are not limited to the effects described above, and other effects that are not described will be clearly understood by those skilled in the art from the above detailed description.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

1. A refrigerator comprising:
an inner case having a storage compartment therein;
an outer case outside the inner case; and
an injection molded insulating member in a spaced region between the inner case and the outer case, the injection molded insulating member including an insulating panel and an insulating material integrally formed together,
wherein the insulating material surrounds at least a portion of the insulating panel.

2. The refrigerator of claim 1, wherein the injection molded insulating member includes:
a first extension portion extending in one direction; and
a second extension portion extending from the first extension portion in a direction different from the one direction.

3. The refrigerator of claim 2, wherein the insulating panel includes:
a first insulating panel having at least a portion within the first extension portion and extending along a direction in which the first extension portion extends; and
a second insulating panel having at least a portion within the second extension portion and extending along a direction in which the second extension portion extends.

4. The refrigerator of claim 3, wherein the outer case includes:
a first sidewall; and
a second sidewall extending from the first sidewall,
wherein the first extension portion extends between the first sidewall and the inner case, and the first extension portion and the first sidewall extend in a same direction, and
the second extension portion extends between the second sidewall and the inner case, and the second extension portion and the second sidewall extend in a same direction.

5. The refrigerator of claim 1, further comprising:
a machine room outside the outer case and accommodating a device configured to supply cold air to the storage compartment,
wherein at least a portion of the injection molded insulating member is between the storage compartment and the machine room.

6. The refrigerator of claim 1, wherein:
the insulating material is a first insulating material,
the injection molded insulating member is in a portion of the spaced region, and
the refrigerator further includes:
a foamed second insulating material in another portion of the spaced region,
wherein the foamed second insulating material is in contact with the injection molded insulating member such that the foamed second insulating material and the injection molded insulating member insulate the storage compartment.

7. The refrigerator of claim 6, wherein the injection molded insulating member includes a plurality of injection molded insulating members, and
at least a portion of the foamed second insulating material is between the plurality of injection molded insulating members.

8. The refrigerator of claim 1, wherein:
the insulating panel includes a vacuum insulating panel, the vacuum insulating panel having:
a core material, and
an outer covering material on an outer side of the core material, the outer covering material forming an accommodation space to accommodate the core material therewithin.

9. The refrigerator of claim 1, wherein the insulating material includes at least one of expanded polypropylene or expanded polystyrene.

10. The refrigerator of claim 1, wherein:
the insulating panel includes a plurality of insulating panels, and
at least some of the plurality of insulating panels are stacked in a direction that is not parallel to a longitudinal direction in which the injection molded insulating member extends.
